(19) United States
(12) Patent Application Publication
(10) Pub. No.: US 2005/0001433 A1
(43) Pub. Date: Jan. 6, 2005

(54) Display system having uniform luminosity and wind generator

(75) Inventor: Srikanth N. Seelin, San Jose, CA (US)

Correspondence Address: Janah & Associates, P.C., Suite 106, 650 Delancey Street, San Francisco, CA, 94107, US

(73) Assignee: Seelink Technology Corporation

(21) Appl. No.: 10/837,548

(22) Filed: Apr. 30, 2004

Related U.S. Application Data
(60) Provisional application No. 60/466,273, filed on Apr. 30, 2003.

(51) Int. Cl. F03D 9/00; H02P 9/04

(52) U.S. Cl. 290/44; 362/485

(57) ABSTRACT

A self-powered display system has a display module with a housing comprising sidewalls and having a display panel comprising signage. An array of light emitting diodes is in the housing. A battery powers the light emitting diodes. A wind generator can also be provided to charge the battery. The wind generator comprises a generator enclosure, a wind turbine in the enclosure to receive an external air flow, and an electrical generator rotor connected to the wind turbine to generate electrical power to charge the battery. In one version, the wind turbine comprises a hollow hub and blades extending radially outward from the hub, with the electrical generator in the hub.

### CROSS-REFERENCE

This application claims priority from U.S. Provisional Patent Application Ser. No. 60/466,273, filed on Apr. 30^{th}, 2003, to Seelin, commonly assigned to Seelink Technology Corporation, California, which is incorporated herein by reference in its entirety.

### BACKGROUND

The present invention relates to a display and electrical generator.

A variety of different displays are used to exhibit advertising on billboards, buildings, sides or backs of moving vehicles, such as for example, vans, buses, tractor trailers, and even boats and aircraft. The simplest type of display is a painting of an advertisement directly on a billboard or the side of the vehicle. However, such displays are difficult to easily change. In the case of buildings, the outside billboard can only be changed with extensive scaffolding and repainting or repapering of the advertisement. Similarly, on vehicles, the message or ad painted on the side has to be repainted to change it.

A further problem arises because conventional displays are often ineffective at night. Thus, lighted panels are used for nighttime displays, for example, by shining incident light from an array of lamps on an advertisement sign. However, the incident lamp array is typically arranged the top or side edges of the panel, and accordingly, does not uniformly illuminate the display panel, but rather only the edges adjacent to the lights. Increasing their brightness can cause excessive glare from the edges of the panels and poor illumination at the central portion of the panel. Some of these problems are addressed by back-lighted displays which typically have a housing with a planar translucent front surface bearing the advertisement images. Fluorescent (neon) or incandescent lamps in the housing back-light the translucent display panel to make the advertising or information visible at a greater distance than if it were lighted by incident light, and thus, more effectively attract the attention of motorists and pedestrians at night. However, the back-lighted display panels also have drawbacks, for example, the relatively large neon or light bulbs in the housing act as linear (for neon) or spot light (for bulb) sources that do not provide uniform levels of illumination across the panel. This results in poor definition of image contours or captions and weakens the visibility and communication effectiveness of the advertisement or message. Increasing the luminosity of the light bulbs, can increase contrast but can also generate excessive blinding or annoying light. Additionally, conventional back-lighted displays are heavy and need scaffolding and frames for supporting the displays. A further problem is the relatively large amount of electrical power needed to operate such signs, typically in excess of several thousands of watts.

Additional problems arise in trying to provide lighted advertisements on vehicles, such as trucks and tractor trailers, which often travel large distances at night. Conventional truck display types include painted metal signs applied to the vehicle surface with adhesives or with magnetic backing and pre-printed advertisement sheets backed by adhesive. Flip-over signs are also used, and these are typically constructed of painted metal sheets that can be reversed, or flipped up and clamped to expose other underlying sheets. These signs can be illuminated with incident light from external lamps powered by the truck generator and battery system. However, as with the front lit advertising signs, the truck's display is also not uniformly lit at night and can be difficult to see. Increasing the wattage of the external incident lights is difficult due to excessive power consumption of the lamps. The vehicle display should have low power consumption to allow the vehicle engine to power the lighted display without exhausting its batteries. Also, excessively bright external lamps can distract other motorists and prevent them from seeing the road. Many states have regulations concerning the level of illumination of truck advertisements to reduce accidents at night. These types of displays also have to be relatively light weight to be mounted on the vehicle.

Thus there is a need for a display that is relatively inexpensive, easy to install, and that can be easily and quickly changed. There is also a need for a lighted display capable of operating at night at a relatively low power level consumption. It is further desirable for the display to be relatively light weight and capable of being mounted on a vehicle. It is also desirable for the display to be able to remain lit even when the vehicle engine is stopped.

### SUMMARY

A self-powered display system has a display module with a housing comprising sidewalls and having a display panel comprising signage. An array of light emitting diodes is in the housing. A battery powers the light emitting diodes.

A wind generator can also be provided to charge the battery. The wind generator comprises a generator enclosure, a wind turbine in the enclosure to receive an external air flow, a generator rotor connected to the wind turbine, the generator rotor capable of generating electrical power to charge the battery.

In one version, the wind-powered generator comprises an enclosure with a wind turbine in the enclosure, the wind turbine comprising (i) a hollow hub, and (ii) blades extending radially outward from the hub, the blades shaped to receive the air flow and drive the hub. An electrical generator is powered by the hub to generate electrical power.

### DRAWINGS

These features, aspects, and advantages of the present invention will become better understood with regard to the following description, appended claims, and accompanying drawings which illustrate examples of the invention. However, it is to be understood that each of the features can be used in the invention in general, not merely in the context of the particular drawings, and the invention includes any combination of these features, where:

FIG. 1 is a perspective partial sectional view of an embodiment of a display module capable of being mounted on a track on the side of a vehicle;

FIG. 2A is a perspective partial sectional view of an circuit board having source and ground lines and holders for mounting an array of LEDs;

FIG. 2B is a perspective partial sectional view of an array of LED holders on a circuit board for holding LEDs;

FIG. 3 is a schematic sectional top view of an embodiment of a wind generator;

FIG. 4 is a perspective view of a vehicle having a display system mounted thereon;

FIG. 5A is a schematic front view of a wind generator and battery system;

FIG. 5B is a schematic top view of a wind generator; and

FIG. 5C is a schematic top view of another embodiment of a wind generator.

FIG. 6A is a schematic perspective view of another embodiment of a wind-powered generator with magnets mounted on the wind turbine which rotates around a stationary toroidal coil;

FIG. 6B is a top view of the wind-generator of FIG. 6A;

FIG. 7A is a schematic perspective view of the back face of a display panel;

FIG. 7B is schematic partial top view of the back face of the display panel of FIG. 7A; and

FIG. 7C is schematic partial sectional side view of a display module having the display panel of FIG. 7A.

### DESCRIPTION

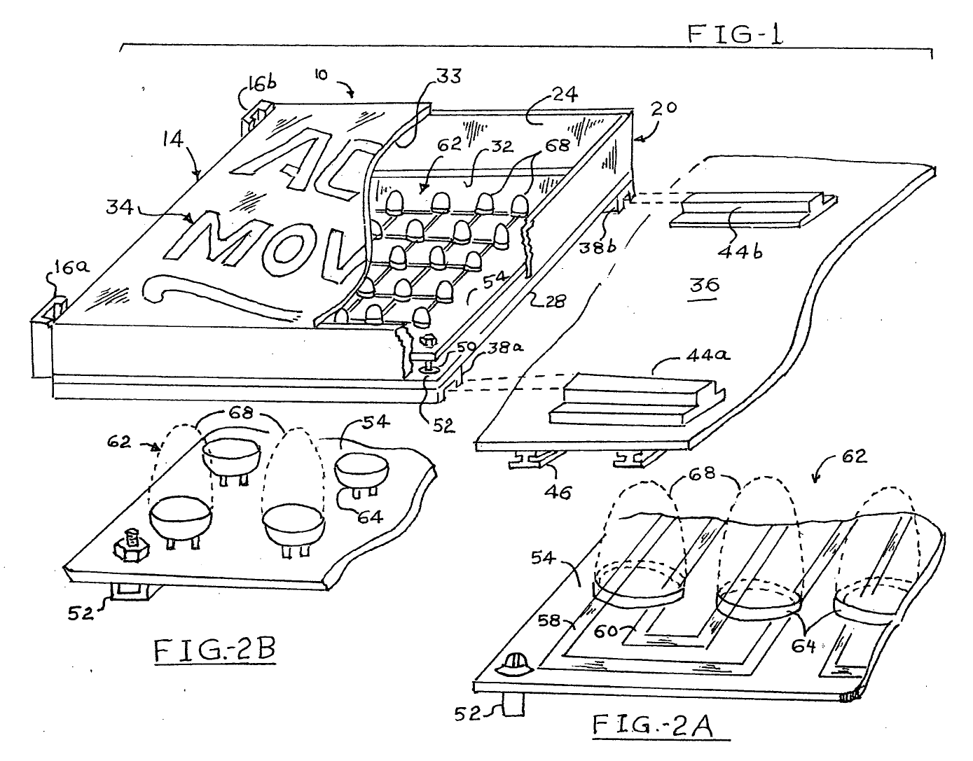

FIG. 1 is a schematic illustration of an embodiment of a display system 10 comprises a display module 14 comprising a housing 20 having sidewalls 24 wrapping around its sides, a back plate 28, and a display panel 30 that forms the front face of the housing 20. Typically, the sidewalls 24 of the housing 20 are made from an opaque plastic material to reduce transmission of light therethrough. The back plate 28 provides structural support and can also be made from a suitable dielectric material, such as acrylic. The back plate 28 can also include a highly reflective surface 32 on the inside of the plate 28 facing the inner surface 33 of the display panel 30. The highly reflective surface can be a surface of the back plate 28, or can be a separate reflective film that is adhered onto the back plate 28, such as a sheet of metalized plastic or metal foil, having an adhesive on its backside. The sidewalls 24 can have internal surfaces that are highly reflective to further enhance light reflection towards the display panel 30.

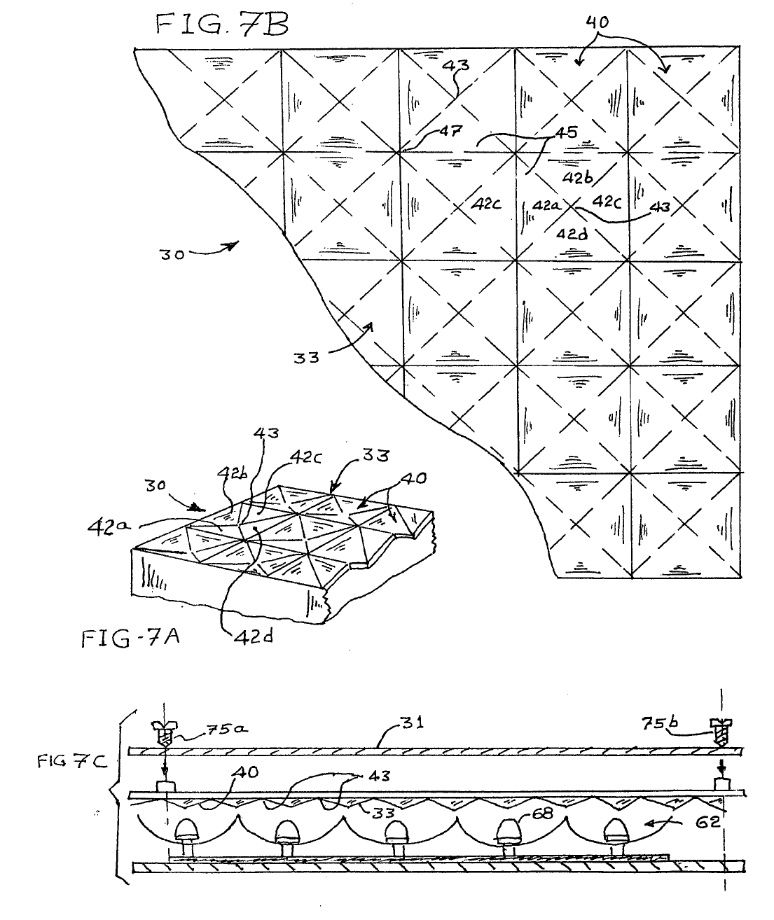

The display panel 30 on the front face of the housing 20 typically comprises a translucent material, such as a cloudy plastic, for example, an acrylic sheet. The display panel 30 can also comprise other materials, such as vinyl laminated or coated polyester fabric panels. An advertising image 34 is applied to the front face 35 of the display panel 30 by painting or computerized printing techniques. Alternatively, the display panel 30 can also include a signage sheet 31 mounted on the front face 35, with the advertising painted, written or printed directly on the signage sheet 31, as shown in FIG. 7C, which makes it easier to change the signage being displayed.

The entire display module 14 may be sized appropriately for mounting on any generally flat surface including billboards, buildings, and vehicles. For example, the display module 14 as shown is suitable for mounting on a vehicular surface 36 such as a sidewall of a truck or tractor trailer. The display module 14 comprises top and bottom edge rails 38a,b that are sized and shaped to slide into top and bottom tracks 44a,b respectively. The tracks 44a,b are riveted or bolted onto the vehicular surface 36. The vehicular surface 36 may be reinforced, for example, by constructing it from reinforcing ribs 46 of may be made from corrugated aluminum sheets (not shown). The display modules 14 can also have interlocking edges 16a,b that allow a series of panels 30 to be joined to one another at their edges to form a larger panel surface.

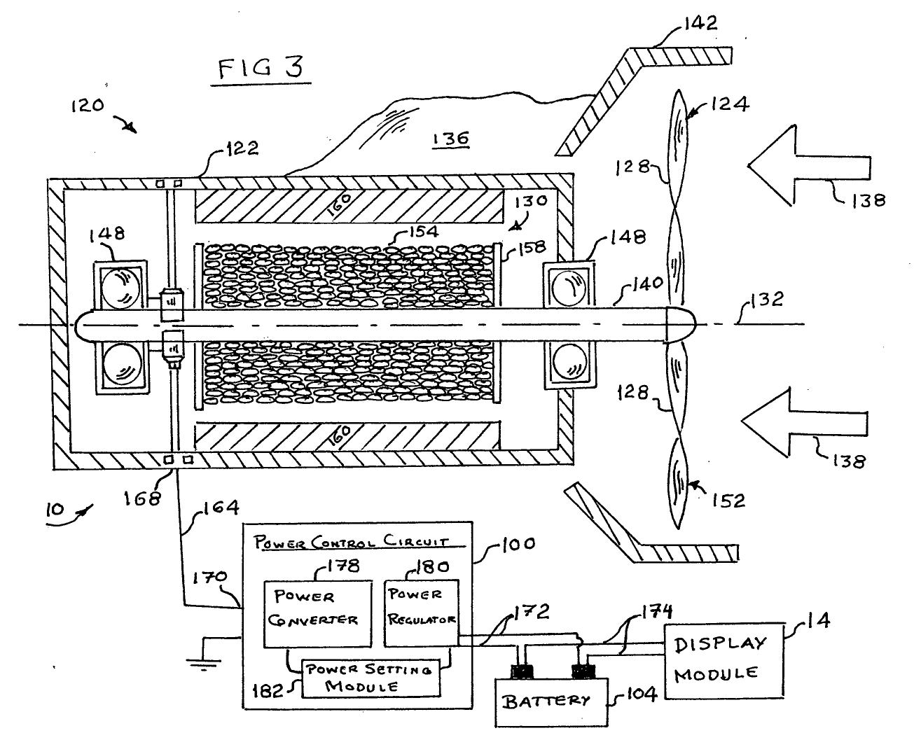

The back plate 28 of the housing 20 can have holes 50 for mounting sockets 52 that can hold a circuit board 54, which can be a printed circuit board, flexible circuit, or dielectric sheet such as a ceramic alumina sheet. The circuit board 54 can have one or more common current source lines 58 and ground source lines 60 to transmit electrical power to an array 62 of light emitting diode (LED) holders 64, as shown in FIG. 2A. The array 62 of holders 64 may be mounted directly on the circuit board 54 or mounted on a separate dielectric board (not shown) with flexible wires connecting the each holder 64 to the lines 58, 60 on the underlying circuit board 54. Each holder 64 provides two connections to an LED 68 received in the holder to pass a current through the LED. The anode of each LED 68 in each column is connected to a current source line 58 and the cathode of each LED 68 to a ground source line 60. Thus, in one configuration, each LED 68 is connected directly to a pair of current and ground source lines. The light emitting LEDs 32 are electrically connected in series, series/parallel, or parallel to accommodate the operating voltage of the devices and the power supply which is being used.

In one configuration, each LED holder 64 consists of surface-treated sheet metal, preferably anodized aluminum, in a bowl-or and semispherical shape that mates with the semispherical back end of an LED 68. Alternatively, when the back-end of the LEDs 68 are flat, for example, when the LEDs are shaped as right cylinders, the LED holders 64 are shaped flat to mate to the flat back-end shape of the LEDs 68. The flat reflective LED holders 64 can also be a portion of a single continuous metal sheet having holes to receive prongs of the LEDs 68.

The LED's 68 are spaced apart from one another and arranged in a periodic arrangement of geometrically predetermined positions, such as the intersection points of a grid or matrix, for example, an m-line by n-column (m×n) matrix, a square matrix or in other configurations that correspond to the shape of the overlying display panel. Typically, for an LED 68 capable of providing a minimum brilliance of 50 mile candelas, a display sized about 2 meters×1 meter will require about 600 to 700 LED's to provide a total brilliance of from about 30,000 mille candelas to about 35,000 mille candelas. For vehicular applications, such as automobiles, the brilliance has to be restricted to from about 3500 to about 5000 millicandelas per sq meter. Practically, with white type LED's this translates to from about 60 to about 100 LED's per sq meter of display, and more preferably from about 70 to about 80 LEDs. However, different numbers of LEDs may be used if the LEDs are colored or depending on other specific applications.

When a current is applied to the array of LEDs 68 they generate an array of light beams which impinges directly on the back or inner surface of the translucent display panel causing luminescence of the translucent panel. The light from the LEDs also reflects from the highly reflective surface on the back plate of the housing. The reflected light also impinges on the back surface 33 of the translucent display panel 30. When the LEDs 68 are energized, and the sign is viewed from the outside of the display panel 30, the printed or painted image or message 34 on the display panel 30 is illuminated from within the display housing 20, whereas the remaining portions of the display panel 30 are dark by contrast, or vice versa. The combination of the large number of small point sources of light generated by the LED array 62, and the light scattering properties of the translucent display panel 30, combine to generate a luminescent display that is uniformly and evenly lit from behind. While FIG. 1 shows LEDs 68 as light emitting devices, other small or uniform light sources, other than LEDs, can also be used, such as miniature electric bulbs that are commonly used in Flashlights.

Another version of a suitable display panel 30 is illustrated in FIGS. 7A to 7C. In this panel, the back face 33 of the display panel 30 comprises an array of open four-sided pyramid surfaces 40 that extend into the plane of the panel 30 to form a honeycomb type of grid of adjacent pyramid shapes. The open pyramid surfaces provide four non-parallel surfaces 42a-d that meet at an apex 43. The base of each open pyramid 40 is formed, for example, by the intersection of lines 45 between adjacent planes 42a, 42e. The pyramid base lines 45 meet at the pyramid intersection points 47. Each pyramid 40 receives incident light from the LED array 62 behind the panel 30, and scatter the light in different directions to provide a more uniform and diffused light behind the signage on the front face of the display panel 30. The LEDs 68 of the array 62 can be positioned symmetrically with respect to the pyramid shapes 40 on the back face 33 of the display panel 30 for example, at the intersection points 47 of the pyramid base lines 45 (as shown in FIG. 7C), or directly below the apexes 47 of the pyramids 40 (not shown). Similarly, the LED holders 64 with reflective surfaces behind the LEDs 68 can also be configured to direct the line onto particular points of the pyramids 40 of the back face 33 to either scatter the light more effectively, or to direct the light onto particular regions of the panel 30. Alternative display panels 30 that operate in the same manner, can have different types of grids, such as a hexagonal honeycomb structure, porosity, or other light scattering modules or particulates included in the display panel structure. The front face of the display panel 30 is smooth and appropriate for receiving signage directly thereon. The display panel 30 can also have a signage sheet 31 that contains the desired advertisement or message that is simply screwed onto the display panel by the screws 75a,b. This version allows the signage sheet 31 of the display panel 30 to be easily replaced without dismantling the underlying display module 14. As another alternative, the display panel 30 can also have a phosphorescent or fluorescent coating thereon to amplify the light generated in the housing 20.

Referring to FIG. 3, a power circuit 100 controls and provides current to the current source line 58 on the circuit board 54. As the LEDs 64 are diodes, which rectify an AC voltage, the power circuit 100 can be operated with either a DC source such as a battery, or directly from an AC source, such as an electrical generator or even an AC line voltage at 120 volts and 60 Hz cycles. A suitable power circuit 100 comprises a power regulator 180 and a power setting module 182 to allow an operator to program or dial-in the desired power level to the LED array 62. A total power load of approximately 1 W per square-foot of the area of the display panel 30 is estimated to be needed in most applications. The actual power applied to the LED array 62 is adjustable utilizing a thyristor (or SCR) integrated into the power circuit 100. This can be designed as a set of custom IC chips (or as ASIC chips) as appropriate for each size or application. Different color LEDs use up different power (eg. white LEDs use 100 lumens but blue light LEDs use about 40 lumens in each unit of measure. The power regulator 180 regulates the power applied to the LEDs 64 by ensuring uniform voltage input through the use of a SCR (Silicon Controlled Rectifier) or equivalent circuits; through using custom ASIC chips of low weight and size. When single or multiple batteries 104 are connected in series or parallel to supply power to the LEDs array 62, the power regulator 180 comprises the above type of circuits. Preferably, the LED array 62 has a total power consumption of less than about 2 watts per sq. foot.

For example, approximately 0.5 W to 1.0 Watts of power per sq. foot is used up from installing eight to ten LED's 64 in a uniformly spaced pattern of an array 62 per sq. foot of panel. The power regulator retrieves the desired power levels from the power settings module 182 and regulates the power applied to the array 62 of LEDs 64 to generate the required level of brilliance of the LEDs 64. For example, when the display 30 is used in vehicular applications, the brilliance of the LEDs has to be controlled to prevent a display 30 that is too bright and fails highway safety regulations. In such an application, the total brilliance of the array 62 of LEDs 64 should preferably be less than about 1000 milli candelas per sq. foot, and more preferably, is from about 500 to about 1000 milli candelas per sq. foot.

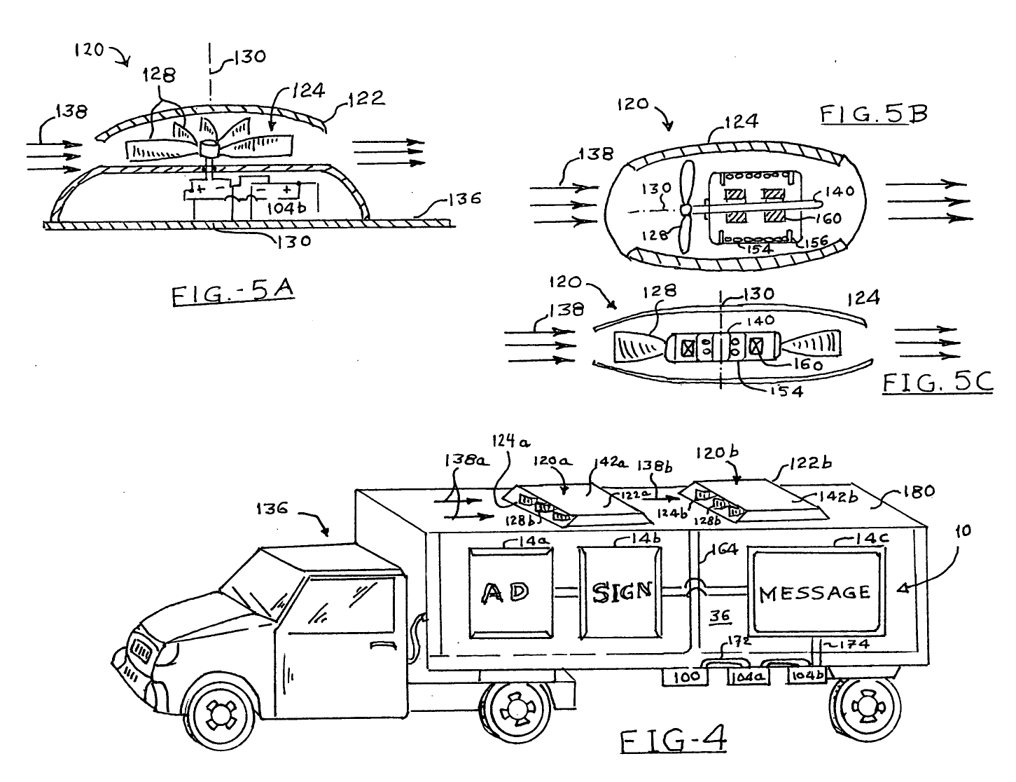

A wind-powered electric generator 120 can also be used to generate power for the array 62 of LEDs 64 of the display module 14. An illustrative embodiment of the wind-powered electric generator 120, as shown in FIG. 3, generally includes an enclosure 122 about a wind powered turbine 124 that drives an electrical generator 130. The turbine 124 has a plurality of blades 128a,b that extend radially from a central axis 132. The turbine 124 may be positioned on a vehicle 136 such that the central axis 132 of the turbine 124 is aligned parallel to the direction of movement of the vehicle 136, also known as a horizontally aligned axis, to cause an air flow 138 to drive the turbine 124, as shown in FIGS. 3 and 5B. In another version, the central axis 130 may also be aligned perpendicularly to the direction of movement of the vehicle 136, also known as a vertically aligned axis, to cause the air flow 138 to drive the turbine blades 128a,b,c as shown in FIG. 5A and 5C.

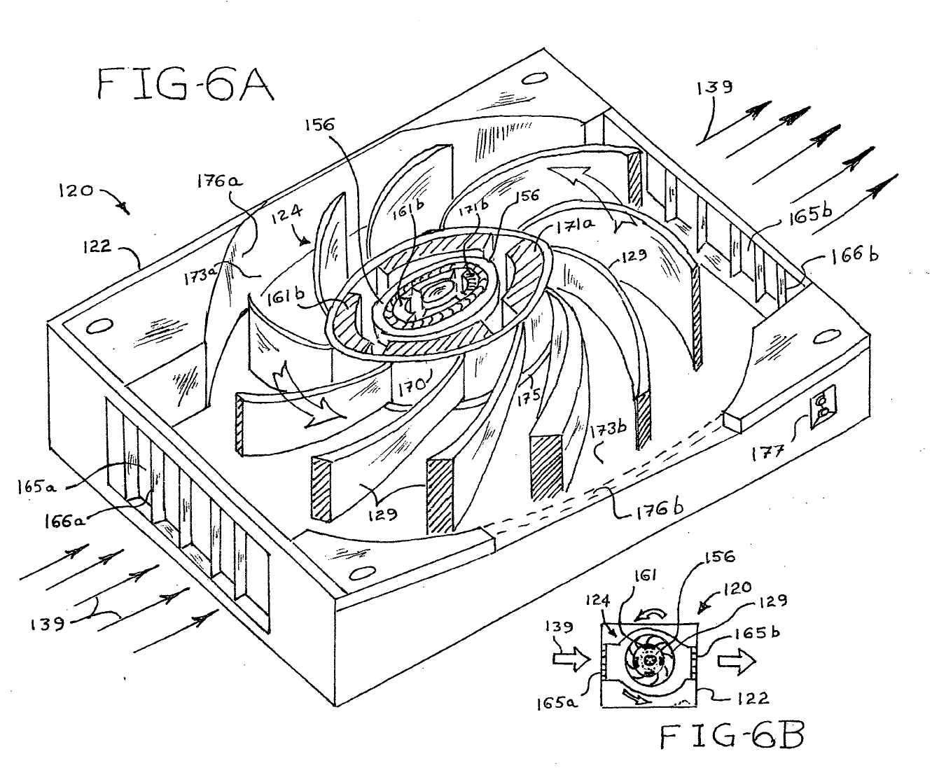

The turbine blades 128 of the wind turbine 124 are deigned in relation to the alignment of the wind generator 120 to the vehicle 136. For example, the turbine blades 128 can comprise extend radially outward perpendicular to the central axis 130, as shown in FIG. 3. In an alternative configuration, the turbine blades 128 form a circular turbine with blades that spiral radially outwards from a central hub as shown in FIGS. 5A, 6A and 6B. An air flow duct 142 can be used to direct the external air flow towards the turbine blades 128, the shape of the duct 142 varying with the shape of the turbine blades 128 and wind flow direction.

The wind turbine 124 is connected to, and drives, an electric generator 130 by a drive shaft 140. The drive shaft 140 may be straight, or it may comprise joints that allow the shaft to bend as it travels from the turbine 124 to the electric generator 130 (not shown). The drive shaft 140 is rotatably mounted by ball bearings 148 within the enclosure 122. Typically, the drive shaft 140 extends perpendicularly outward from the wind turbine 124 and powers an electrical generator 130.

The electric generator 130 is generally contained in a generator enclosure 144 with drive shaft 140 extended into the generator 130. In the version shown in FIG. 3, the generator 130 comprises a coil 154 within a hollow cylindrical sleeve 158, which in turn is fixed to the drive shaft 140. The coil 154 can be a single continuous torroid of electrical conductor, such as copper wire, or discrete separate torroids that are electrically connected in series or parallel. The coil 154 is positioned within one or more magnets 160 positioned circumferentially about the central axis 130 of the drive shaft 140. When the coil 154 is moved through the magnetic field generated by the magnets 160, electric current is induced in the conductor of the coil 154. Thus, the mechanical energy generated by the drive shaft 140 and the wind turbine 124 is converted into an electric current that flows in the coil wire. In an alternative arrangement, the coil 154 may be stationary and the magnets 160 affixed to the drive shaft 140 and rotating within the coil 154, as shown in FIG. 5B.

In the alternate embodiment, illustrated in FIGS. 6A and 6B, the wind-powered generator 120 comprises a wind turbine 124 comprising a set of turbine blades 129 that each spiral outward from a hollow hub 170 and that are enclosed in a generator enclosure 122. The blades 129 extend radially outwardly from the hollow hub 170 in an arcuate shapes that form outwardly spiraling spokes. The hollow hub 170 has concentric double walls 171a,b, including a first outer wall 171a and a second inner wall 171b that is radially inward of the outer wall, at least one wall 171a,b having magnets 161a,b mounted thereon, respectively. The magnets 161a,b can be shaped as semi-circular arcs that fit the shape of the walls of the hub 170. A bearing 175 supports the turbine blades 129 and allows them to rotate around a stationary toroidal coil 156 positioned at the center of the hub 170. An electrical outlet 177 is connected to electrical wires that lead to the coil 156 built into the housing 122 to provide the power generated in the toroidal coils 156 to the external environment. The wind flow, as shown by the arrow 139, enters the air duct inlet 165a, passes between the channels 173a,b formed by the circumferential walls 176a,b and the blades 129, and exits from the air duct outlet 165b. The circumferential walls 176a,b are optional and connect the air inlet duct 165a to the air duct outlet 165b, and has a gap therebetween and the blades 129. The walls 176a,b further direct and channel the air flow 139 through the wind-powered generator 120. The inlet 165a and outlet 165b can also have vanes 166a,b that can be parallel to the direction of the airflow or oriented at an angle to direct the incoming wind flow into an optimal angle of incidence onto the wind turbines blades 129. This version operates analogous to a water-wheel, with airflow in direction 139 driving the wind turbine.

The power circuit 100 can be mounted within the generator enclosure 122, or can be in a separate external housing. The power circuit 100 is connected to the coil 154 by an electrical wire 164 for receiving the power generated by the coil 154 and transmitting the power to a battery 104. The wire 164 has a first termination 168 connected to the wind-powered generator 120, a second termination connected to the power circuit 100. A second wire 172 connects the power circuit 100 to the battery 104, and a third wire 174 connects the battery 104 to the display module 14. Any of the first, second or third wires 164, 172, or 174, can be made with a magnetic backing to allow the wires to be easily affixed onto a vehicle surface 36 of a vehicle 136. The magnetic backing allows the wires 164, 172, 174 to be easily attached, reconfigured, or detached from a the vehicle surface 36, which is useful for retrofitting the display system 10 onto trucks and trailers.

The power circuit 100 regulates can also include a power converter 178 to convert the power generated by the electric generator 130 to a power suitable for use in recharging the battery 104. For example, the power converter 178 can convert an AC power delivered by the electrical generator 130 to a DC power that it delivers to the battery 104. In one configuration, the power converter 178 comprises a fan-Rotor combination similar to that illustrated in FIG. 7, along with appropriate shock- and vibration-damping mountings in a mechanical sub-system.

FIG. 4 shows an embodiment of the display system 10 suitable for mounting on a vehicle 136. Generally, the air flow 138a,b across the roof 180 of the vehicle drives a series of roof mounted wind turbines 124a,b that each power an electrical generator 130a,b. The blades 128a,b of the turbines 124a,b are each mounted in separate air ducts 142a,b which are positioned either one behind another (as shown) or side by side (not shown), such that the turbines 124a,b are all driven by the air flow 138a,b. The wiring 164 provides the electrical power generated by the wind-powered generators 120a,b to a power circuit 100 mounted below the vehicle which in turn is connected to the batteries 104a,b by the wires 172. The batteries 104a,b feed the displays 14a,bn,c through the wire 174. Such a display system 10 can be easily retrofitted onto existing or old vehicles 136, especially trucks and tractor trailers, to provide an easily readily softly, and uniformly, illuminated display.

Although exemplary embodiments of the present invention are shown and described, those of ordinary skill in the art may devise other embodiments which incorporate the present invention, and which are also within the scope of the present invention. For example, other types of display housings and display panels can also be used. The LED light sources can also be replaced by equivalent light sources as would be apparent to one of ordinary skill in the art. Also, other types of power generators can be used to power the LED array of the display. Furthermore, relative or positional terms shown with respect to the exemplary embodiments are interchangeable. Therefore, the appended claims should not be limited to the descriptions of the preferred versions, materials, or spatial arrangements described herein to illustrate the invention.

1. A self-powered display system comprising:
(a) a display module comprising:
(i) a housing comprising sidewalls and having a display panel comprising signage;
(ii) an array of light emitting diodes in the housing, and
(b) a battery to power the light emitting diodes; and
(c) a wind-powered generator to charge the battery, the wind generator comprising:
(i) an enclosure;
(ii) wind turbine in the enclosure to receive an external air flow and drive a drive shaft; and
(ii) a electrical generator powered by the drive shaft in the enclosure, the electrical generator capable of generating electrical power to charge the battery.

2. The display of claim 1 wherein the array of light emitting diodes has a brilliance of less than about 1000 milli candela per sq foot.

3. The display of claim 2 wherein the array of light emitting diodes has a brilliance of from about 500 to about 1000 milli candela per sq. foot.

4. The display of claim 1 wherein the array of light emitting diodes has a total power consumption of less than about 2 watts per sq foot.

5. The display of claim 1 wherein the display module comprises either of:
(1) a back plate with a magnetic backing to attach the display module; or
(2) top and bottom edges that slide onto receiving tracks fixed on a vehicle.

6. The display of claim 1 comprising a power circuit that regulates the power applied to the array of light emitting diodes by balancing the heat and power loads of the array of light emitting diodes.

7. The display of claim 1 wherein the back plate comprises a reflective surface.

8. A wind-powered generator comprising:
(a) an enclosure;
(b) wind turbine in the enclosure, the wind turbine comprising (i) a hollow hub, and (ii) blades extending radially outward from the hub, the blades shaped to receive the air flow and drive the hub; and
(c) a electrical generator powered by the hub, the electrical generator capable of generating electrical power.

9. The wind-powered generator of claim 8 wherein the blades each spiral outward from the hollow hub.

10. The wind-powered generator of claim 8 wherein the hollow hub has concentric inner and outer walls.

11. The wind-powered generator of claim 8 wherein the electrical generator is in the hollow hub.

12. The wind-powered generator of claim 11 wherein the electrical generator comprises magnets mounted on at least one of the inner and outer walls of the hub with a coil is positioned at the center of the hub.

13. The wind-powered generator of claim 12 wherein the magnets are shaped as semi-circular arcs that fit the shape of the walls of the hub.

14. The wind-powered generator of claim 8 wherein the housing comprises an air duct inlet and an air duct outlet, and a circumferential wall connecting the air duct inlet to the outlet, the circumferential wall being radially outward of the hub and surrounding the blades with a channel therebetween.

15. The wind-powered generator of claim 14 comprising inlet vanes in at lest one of the air duct inlet or air duct outlet, the vanes being oriented at an angle to direct the incoming wind flow into an optimal angle of incidence onto the blades of the wind turbine.

16. A self-powered display system comprising:
(a) a display module comprising:
(i) a housing comprising sidewalls and having a display panel comprising signage;
(ii) an array of light emitting diodes in the housing, and
(b) a battery to power the light emitting diodes; and
(c) a wind-powered generator comprising:
(i) an enclosure;
(ii) wind turbine in the enclosure, the wind turbine comprising (1) a hollow hub, and (2) blades extending radially outward from the hub, the blades shaped to receive the air flow and drive the hub; and
(ii) a electrical generator powered by the hub, the electrical generator capable of generating electrical power.

17. The wind-powered generator of claim 16 wherein the electrical generator comprises magnets mounted on walls of the hub, and a coil is positioned at the center of the hub.

18. The wind-powered generator of claim 16 wherein the housing comprises (i) an air duct inlet and an air duct outlet, (ii) a circumferential wall connecting the air duct inlet to the outlet, the circumferential wall being radially outward of the hub and surrounding the blades with a channel therebetween, and (iii) vanes in the air duct inlet or air duct outlet, the vanes being oriented at an angle to direct the incoming wind flow into an optimal angle of incidence onto the blades of the wind turbine.
